(19) United States
(12) Patent Application Publication
(10) Pub. No.: US 2024/0249033 A1
(43) Pub. Date: Jul. 25, 2024

(54) SECURING INPUT DEVICE DATA

(71) Applicant: Microsoft Technology Licensing, LLC, Redmond, WA (US)

(72) Inventor: Randall Richards COOK, Redmond, WA (US)

(21) Appl. No.: 18/100,345

(22) Filed: Jan. 23, 2023

(51) Int. Cl. G06F 21/83; G06F 21/60

(52) U.S. Cl. CPC G06F 21/83; G06F 21/602

(57) ABSTRACT

The technology described herein secures input data during communication between an input device and an input destination, such as an application or container. In an aspect, the input device is a keyboard. The technology described herein may enable a keyboard to communicate in a standard mode and a secure mode. In the standard mode, the keyboard communicates like currently available keyboards. In secure mode, the keyboard may provide several security enhancements including the encryption of keystrokes with decryption occurring at the input destination. The security enhancements can include building a secure communication channel between the keyboard and the input destination. The security enhancements can include an attestation to the user that the keyboard is operating in secure mode.

### CROSS-REFERENCE TO RELATED APPLICATIONS

None.

### BACKGROUND

Schemes to fraudulently acquire another person's credential and password information have become common. Some schemes include user action, in which a user inputs information to an application through a human-computer interface, such as a keyboard. An operating system can be compromised using interception tactics, such as keystroke logging. Keyloggers can be difficult to detect and remove from an operating system. In view of the foregoing, there is a need for techniques that facilitate secure communication between an input device and an application running on a computing device.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The technology described herein secures input data during communication between an input device and an input destination, such as an application or container. Much of the present description will use a keyboard as the example input device, but the technology described herein may be used with other input devices, such as a touchpad, a smart stylus, a camera, a microphone, and/or a touchscreen. The technology described herein may enable a keyboard to communicate in a standard mode and a secure mode. In the standard mode, the keyboard communicates like currently available keyboards. The standard mode allows the keyboard to communicate with input destinations that are not capable of receiving secure communications. In secure mode, the keyboard may provide several security enhancements.

The security enhancements may include the encryption of keystrokes, with decryption occurring at the input destination. The security enhancements may include building a secure communication channel between the keyboard and the input destination. The security enhancements may include providing an attestation to the user that the keyboard is operating in secure mode. Implementation of the security enhancements may require coordination between the keyboard and the input destination. In aspects, a first security application is present at the input device, and a second security application is present at the input destination. As an alternative, a first security application may be present within an input device driver at a hardware layer of a host operating system (OS), instead of at the input device itself.

The input destination may be defined as the application or container in control focus. An OS may determine control focus in response to user inputs. For example, a user clicking on or otherwise selecting a graphical user interface feature associated with an application may bring the application into control focus. Subsequent keyboard inputs may be routed to the application that is in control focus. Typically, an input device is not aware of which application or object is in control focus. In other words, the input device typically communicates input to an unknown input destination. Not all containers or applications on the host OS may be security enabled. Accordingly, the input device may alternate between secure mode and standard mode depending on which container or application is in control focus. For example, when a non-security enabled container is in control focus, the input device switches to standard mode. Additionally, when the control focus switches between two security-enabled containers, the input device may maintain secure mode, but an encryption method used by the input device may change to correspond to the in-focus input destination, as described in additional detail herein.

In aspects, activation of a secure mode may be initiated by the input destination. The input destination may recognize that the input device is capable of implementing a secure mode and send an initiation request to the input device. The input device may provide a credential in response to the initiation request. The credential may indicate to the input destination that the input device can be trusted and is, in fact, the intended input device, rather than an application spoofing an input device. Upon validation, a confirmation may be communicated to the input device. The confirmation can include communication protocol(s) and/or encryption protocol(s) for the input device to follow when communicating with the input destination. The communication protocols and/or encryption protocols may be unique to the input destination. The unique encryption protocols ensure that intercepted keystrokes cannot be easily understood by any destination other than the particular input destination. The unique communication protocols may create an alternative communication channel between the input device and input destination that may be difficult to monitor in the first place because the alterative communication channel may be known only to the input device and input destination. In contrast, in standard mode, all keystrokes may follow a single communication channel that may be described in various technical specifications. For example, the standard communication channel may include an unsecured keystroke queue through which all keystrokes pass. A process for accessing the keystroke queue may be described in technical specifications so that application developers know how to program their applications to access keystrokes from the keystroke queue. This information can be leveraged by monitoring applications. Conceptually, the unique communication protocols may make it difficult for a bad actor to know how to access keystrokes.

Upon implementing the communication protocol(s) and/or encryption protocol(s), the input device may output an attestation (e.g., visual, haptic, audible) that a secure mode is active. A user interface associated with the input destination may likewise provide an attestation (e.g., visual, haptic, audible) that a secure mode is active. In aspects, when the control focus is moved off the input destination, then the input destination may provide a termination message to the input device. The input device may then return to standard mode, until a new secure mode initiation request is received. When back in standard mode, the attestation provided by the input device and/or the user interface may be removed. Alternatively, instead of removal, a new audible, visible, or haptic indication may be output to indicate that standard mode is active.

### BRIEF DESCRIPTION OF THE DRAWINGS

The technology described herein is illustrated by way of example and not limitation in the accompanying figures in which like reference numerals indicate similar elements and in which:

FIG. 1 is a diagram of a computing system suitable for implementations of the technology described herein;

FIG. 2 is a block diagram of an example operating environment suitable for implementations of the technology described herein;

FIG. 3 is a block diagram of an example operating environment suitable for implementations of the technology described herein;

FIG. 4 is a flow diagram showing a method of secure communication, in accordance with an aspect of the technology described herein;

FIG. 5 is a flow diagram showing a method of secure communication, in accordance with an aspect of the technology described herein;

FIG. 6 is a flow diagram showing a method of secure communication, in accordance with an aspect of the technology described herein; and

FIG. 7 is a block diagram showing a computing device suitable for implementations of the technology described herein.

### DETAILED DESCRIPTION

The various technologies described herein are set forth with sufficient specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

The technology described herein secures input data during communication between an input device (e.g., keyboard) and an input destination, such as an application or container. Much of the present description will use a keyboard as the example input device, but the technology described herein may be used with other input devices, such as a touchpad, a smart stylus, a camera, a microphone, and/or a touchscreen. The technology described herein may enable a keyboard to communicate in a standard mode and in a secure mode. In the standard mode, the keyboard communicates like currently available keyboards. The standard mode allows the keyboard to communicate with input destinations that are not capable of receiving secure communications. In secure mode, the keyboard may provide several security enhancements.

The security enhancements may include the encryption of keystrokes, with decryption occurring at the input destination. The encryption of keystrokes increases the difficulty of extracting useful information from the keystrokes if the keystroke is intercepted between the keyboard and destination. The security enhancements may include establishing a secure communication channel between the keyboard and the input destination. The security enhancements may also include providing an attestation to the user that the keyboard is operating in secure mode. Implementation of the security enhancements may require coordination between the keyboard and the input destination. In an aspect, a first security application is present at the input device and a second security application is present at the input destination. As an alternative, a first security application may be present within an input device driver at a hardware layer of a host OS, instead of at the input device itself.

The input destination may be defined as the application or container in control focus. Control focus may be a state characteristic of an application. An operating system (OS) may determine control focus in response to user inputs. For example, a user clicking on or otherwise selecting a graphical user interface feature associated with an application may bring the application into control focus. Subsequent keyboard inputs may be routed to the application that is in control focus. Typically, an input device is not aware of which application or object is in control focus. In other words, the input device typically communicates input to an unknown input destination.

Not all containers or applications on the host OS may be security enabled. Accordingly, the input device may alternate between secure mode and standard mode depending on which container or application is in control focus. For example, when a non-security enabled container is in control focus, the input device switches to standard mode. Additionally, when the control focus switches between two security-enabled containers, the input device may maintain secure mode, while the encryption method used by the input device may change to correspond to the in-focus input destination's method.

In aspects, activation of a secure mode may be initiated by the input destination. The input destination may recognize that the input device is capable of implementing a secure mode and send an initiation request to the input device. The input device may provide a credential in response to the initiation request. The credential may indicate to the input destination that the input device can be trusted and is, in fact, a real input device, rather than a program spoofing an input device. Upon validation, a confirmation may be communicated to the input device. The confirmation can include communication protocol(s) and/or encryption protocol(s) for the input device to follow when communicating with the input destination. The communication protocol(s) and/or encryption protocol(s) may be unique to the input destination. The unique encryption protocols ensure that intercepted keystrokes cannot be easily decrypted by other programs. The unique communication protocols may create an alternative communication channel between the input device and input destination that may be difficult to monitor in the first place because the alterative communication channel may be known only to the input device and input destination. In contrast, in standard mode, all keystrokes may follow a single communication channel that may be described in various technical specifications. For example, the standard communication channel may include an unsecured keystroke queue through which all keystrokes pass. A process for accessing the keystroke queue may be described in technical specifications so that application developers know how to program their applications to access keystrokes from the keystroke queue. This information can be leveraged by monitoring applications. Conceptually, the unique communication protocols may make it difficult for a bad actor to know how to access keystrokes.

Upon implementing the communication protocol(s) and/or encryption protocol(s), the input device may output an attestation (e.g., visual, haptic, audible) that a secure mode is active. A user interface associated with the input destination may likewise provide an attestation (e.g., visual, haptic, audible) that a secure mode is active. In aspects, when the control focus is moved off the input destination, then the input destination may provide a termination message to the input device. The input device may then return to standard mode, until a new secure mode initiation request is received. When back in standard mode, the attestation provided by the input device and/or the user interface may be removed. Alternatively, instead of removal, a new audible, visible, or haptic indication may be output to indicate that standard mode is active.

The secure communication channel allows bi-directional communication between the input destination and the input device. The secure communication channel provides a path for communication of encrypted input between the input device and the container. This path may differ from the traditional communication path for input handling in the host OS.

In existing computing environments, a keyboard may generate a scan code based on a keystroke or a combination of keystrokes (e.g., shift+A). The scan code is communicated through a wired or wireless connection to the computing device. The scan code may take the form of a series of bytes. A function on the computing device may translate the scan code into a corresponding text code. The text code is then communicated to the application or container in control focus through an input application program interface (API). In aspects, the text code may be communicated in the form of an input event. The same text code may be used for all applications running on the computing device. Thus, the text code is easily understood, if intercepted.

In contrast, the technology described herein improves the security of data transmitted between an input device (e.g., keyboard) and an input destination operating in a host OS by implementing a secure mode. The secure mode protects the input data from a compromised host OS. In a compromised host OS, data flow between components operating in the host OS may be vulnerable to data interception tactics. For example, a key logger can intercept data being routed over the host OS. The technology described herein changes this arrangement in one or more ways that render the text code difficult to understand, if intercepted. The text code may be rendered difficult to understand through encryption. The encryption can take several forms.

The technologies herein are described using key terms wherein definitions are provided. However, the definitions of key terms are not intended to limit the scope of the technologies described herein.

An operating system is a program (or set of programs) that manages the resources on a computing device. Typically, the operating system offers these resources to a user through programs called applications. Applications perform tasks such as word-processing, gaming, internet activities, etc. The operating system is an intermediary between the applications and the computer hardware. Operating systems have libraries of programs that applications can use to create standardized user interaction.

An input device is a hardware component of a computer or electronic device that allows a user to send data to the device. Input devices convert physical actions or analog signals into digital data that a computer can understand and process. Example input devices include a keyboard, mouse, touchscreen, touch pad, microphone, camera, and stylus.

A keyboard is a peripheral input device that uses an arrangement of buttons or keys to act as mechanical levers or electronic switches that receive input. The buttons or keys may each correspond to a value (e.g., number or letter).

An encryptor is an algorithm, software application, or device that encrypts data, such as keystrokes. Encryption is the process of converting or scrambling data and information (plain text) into an unreadable, encoded version (cipher text) that can only be read with a decryption key. Encryption may use a cryptographic key. A cryptographic key may be a set of mathematical values. Data can be encrypted “at rest,” when it is stored, or “in transit,” while it is being transmitted somewhere else.

Decryption is the reverse process of encryption. It is a procedure of transforming cipher text into plain text. Cryptography uses a decryption technique at the receiver side to acquire the original message from cipher text. Decryption operates by using the opposite conversion algorithm used to encrypt the data. The same key is used to return the encrypted data to its original form. In decryption, the system extracts and transforms the encrypted data to text and images that are comprehensible to a user.

Containerization is a process of operating system-level virtualization or application-level virtualization over multiple computer resources so that software applications can run in isolated user spaces called containers. A single container might be used to run anything from a small microservice or software process to a larger application. Inside a container are all the necessary executables, binary code, libraries, and configuration files to run the service or process.

Having briefly described an overview of aspects of the technology described herein, an operating environment in which aspects of the technology described herein may be implemented is described below in order to provide a general context for various aspects.

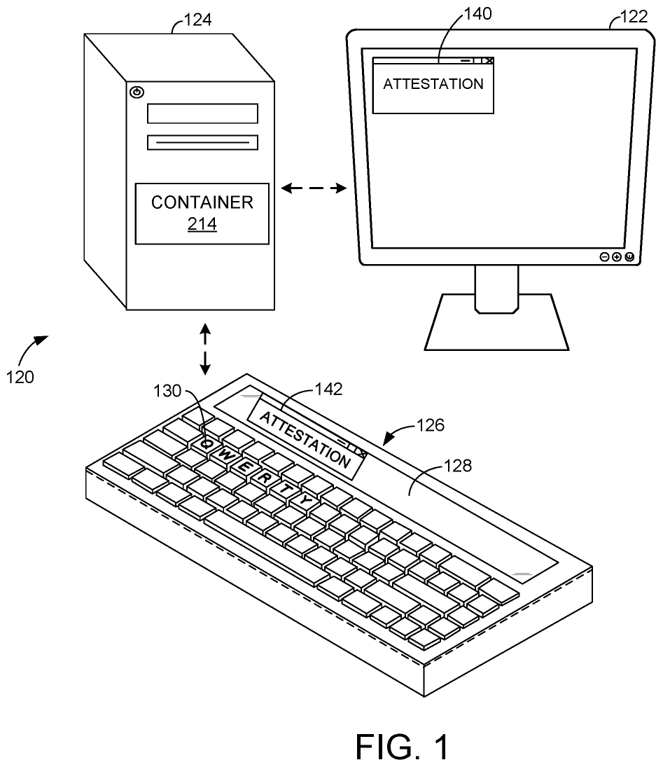

Turning now to FIG. 1, a computing environment suitable for use with aspects of the technology described herein is provided. While the technology can secure different types of input devices, a keyboard is used as an example input device throughout much of this disclosure. In FIG. 1, a secure communication channel is used to communicate input data from the input device to an input destination (e.g., container or application 214) running on a computing device 124.

FIG. 1 illustrates a computing system 120 including a display monitor 122, a computing device 124 (e.g., containing a processor, memory, hard drive), and a computer peripheral in the form of keyboard 126. The computing device 124 may be in wired or wireless communication with the display monitor 122 and the keyboard 126. Aspects of the technology secure the communication of keystrokes between the keyboard 126 and a container operating on the computing device 124. The use of a secure connection and encryption improves the security of input data.

In some examples, the keyboard 126 is also a computing device. The computing device 126 includes a processor, memory, and software components able to form a secure connection and encrypt keystrokes before transmittal. The keyboard 126 may be able to communicate with containers and applications in order to form a secure connection. The formation of a secure connection may include the exchange of messages and security tokens.

Individual keys 130 on the keyboard 126 may be depressed to provide input, for example, in the form of electrical signals to computing system 120. The terms “input” and “output” are used in this description in reference to example keyboard actions. When used in connection with a keyboard key, the term “input” will generally refer to the input signal that is generated by the keyboard in response to operation of the key. “Output” will generally refer to the data provided to the computing device 126. In standard mode, the output may be a scan code. In secure mode, the output may be an encrypted data packet.

Under conventional techniques, a keyboard may generate an output in the form of unencrypted scan code. A scan code corresponds to a keystroke or combination of keystrokes (e.g., shift+A). The scan code is communicated through a wired or wireless connection to the computing device 124. The scan code may take the form of a series of bytes. A function on the computing device (e.g., a keyboard driver) may translate the scan code into a corresponding text code. The text code is then communicated through the operating system to a destination application or container. The destination application or container may be determined by the user-interface control focus. In aspects, the text code may be communicated in the form of an input event. The same text code may be used for all applications running on the computing device. Thus, currently, the text code is easily understood, if intercepted.

Computing system 120 is one example of a system that may be used to implement the technology described herein. The technology implements security in communications between a component and an input device, such as a keyboard. While the keyboard 126 is the only input device shown, it is contemplated that the output of different input devices may be secured by the technology described herein.

The computing system 120 may comprise any type of computing device capable of use by a user. By way of example and not limitation, computing system 120 may be embodied as a personal computer (PC), a laptop computer, a mobile phone or mobile device, a smartphone, a tablet computer, a smart watch, a wearable computer, a personal digital assistant (PDA), a music player or an MP3 player, a global positioning system (GPS) or device, a video player, a handheld communications device, a gaming device or system, an entertainment system, a vehicle computer system, an embedded system controller, a camera, a remote control, a bar code scanner, a computerized measuring device, an appliance, a consumer electronic device, a workstation, or any combination of these delineated devices, or any other suitable computer device.

In aspects, the initiation of secure mode may start with the keyboard 126 receiving a request to enter secure mode from an input destination (e.g., software application or container) running on the computing device 124. In response to receiving the request, communication of an authentication code may be initiated at keyboard 126. The authentication code is communicated to the input destination. A secure communication channel is established between the input destination and keyboard 126. Multiple input destinations may establish secure connections with keyboard 126. A visual attestation 142 is displayed on the keyboard's display 128. The visual attestation 142 shows that the keyboard 126 is in secure mode and that security policies are actively securing the transfer of data between the keyboard 126 and an in-focus input destination running on the computing device 124. In some examples, a display 128 on the keyboard, such as a liquid crystal display (LCD) device, provides a textual message on the LCD display as an attestation 142. Alternatively, the visual attestation on the keyboard 126 could be a lighted key, an LCD light, and/or an icon on the LCD display. In the case of a textual message, the message could identify the container or software application that is the current input destination.

In an aspect, a second attestation 140 could be output through a graphical user interface generated by the input destination (e.g., container 214). The active status of the secure mode may also be used by the container in different ways. For example, the display of a UI element designed to receive private information (e.g., a password, social security number, birth date, bank account) could be prevented unless the secure mode is active. Instead of preventing display, various warnings could be provided to discourage the user from or warn the user about entering data using an unsecure input device.

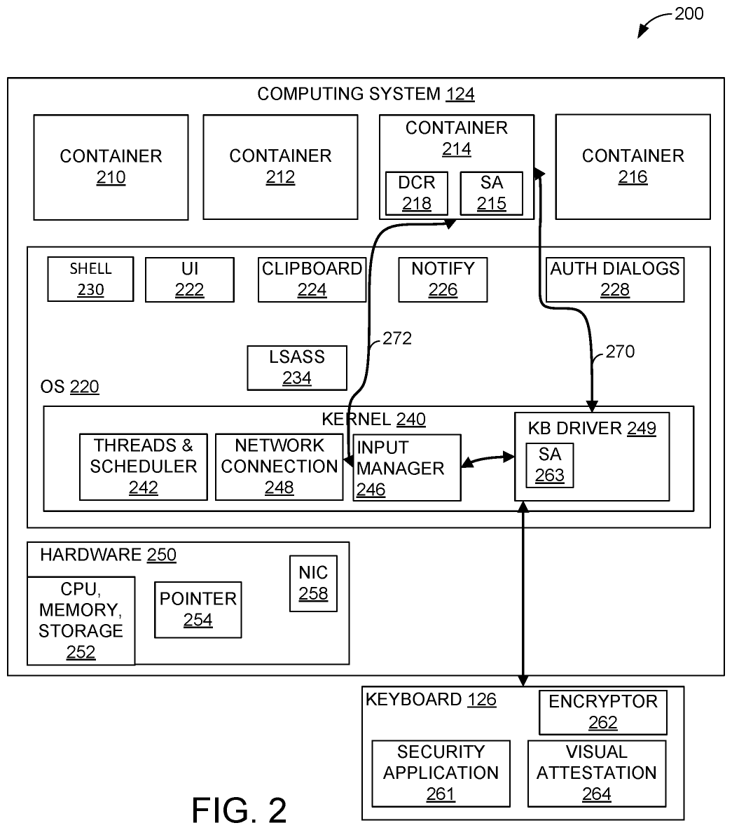

Referring now to FIG. 2 with FIG. 1, a block diagram is provided showing aspects of an example computing system architecture suitable for implementing some embodiments of the disclosure and designated generally as system 200. FIG. 2 illustrates the formation of a secure connection between the keyboard 126 and the container 214, which is an example input destination.

The system 200 represents only one example of a suitable computing system architecture. Other arrangements and elements can be used in addition to or instead of those shown, and some elements may be omitted altogether for the sake of clarity. Further, as with operating environment 100, many of the elements described herein are functional entities that may be implemented as discrete or distributed components or in conjunction with other components, and in any suitable combination and location.

Example system 200 provides a detailed view of components of keyboard 126 and the computing system 124, including an operating system 220, hardware layer 250, and example containers 210, 212, 214, and 216. Together with components not shown, the operating system 220 components may be described as an operating system. These components may be embodied as a set of compiled computer instructions or functions, program modules, computer software services, or an arrangement of processes carried out on one or more computer systems.

In one embodiment, the functions performed by components of system 200 are associated with securing input data transfer between an input device and an input destination, such as a container or application. These components, functions performed by these components, and/or services carried out by these components may be implemented at appropriate abstraction layer(s) such as the operating system layer, application layer, and/or hardware layer of the computing system(s). Alternatively, or in addition, the functionality of these components, and/or the embodiments described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs). Additionally, although functionality is described herein with regards to specific components shown in example system 200, it is contemplated that in some embodiments functionality of these components can be shared or distributed across other components and/or computer systems.

The hardware layer 250 comprises one or more central processing units (CPUs), memory, and storage 252, a pointer 254, and a network interface controller (NIC) 258. The pointer 254 may be a mouse, track ball, touch screen, touch pad, natural user input (e.g., gesture) interface or another input device that controls a location of an interface pointer. The keyboard is shown separate from the hardware to illustrate that external keyboards may be used with the technology described herein. However, internal keyboards, such as found on laptops, may also be used with the technology described herein. Similarly, in some aspects, a virtual keyboard displayed on a touchscreen may be used with the technology described herein.

The NIC 258 (also known as a network interface card, network adapter, local area network (LAN) adapter or physical network interface, and by similar terms) is a computer hardware component that connects a computer to a computer network. The NIC allows computers to communicate over a computer network, either by using cables or wirelessly. The NIC may be both a physical layer and data link layer device, as it provides physical access to a networking medium and, for IEEE 802 and similar networks, provides a low-level addressing system through the use of MAC addresses that are uniquely assigned to network interfaces. In aspects, an Internet connection may be used to authenticate the keyboard to the input destination.

The operating system 220 components include kernel 240 components. Many components of the operating system, such as a hardware abstraction layer between the hardware 250 and the kernel 240 components, are not shown. The kernel 240, of which the kernel components 242-249 are a part, is a computer program at the core of a computer's operating system and has control over the system. The kernel 240 facilitates interactions between hardware and software components. The kernel 240 controls hardware resources (e.g., input/output (I/O), memory) via device drivers, arbitrates conflicts between processes concerning such resources, and optimizes the utilization of common resources (e.g., CPU, memory, and storage 152). On some systems, the kernel 240 is one of the first programs loaded on startup (after the bootloader). Once loaded, the kernel 240 may handle the rest of startup as well as memory, peripherals, and I/O requests from software, translating them into data-processing instructions for the CPU.

The code of the kernel 240 may be loaded into a separate area of memory, which is protected from access by application software or other, less critical parts of the operating system. The kernel 240 performs its tasks, such as running processes, managing hardware devices such as the hard disk, and handling interrupts, in this protected kernel space. This separation helps prevent user data and kernel data from interfering with each other and causing instability and slowness, as well as preventing malfunctioning applications from affecting other applications or crashing the entire operating system.

When a user-mode application starts, the operating system creates a process for the application. The process provides the application with a private virtual address space and a private handle table. Because an application's virtual address space is private, one application cannot alter data that belongs to another application. In addition to being private, the virtual address space of a user-mode application is limited. A processor running in user mode cannot access virtual addresses that are reserved for the operating system. Limiting the virtual address space of a user-mode application prevents the application from viewing, altering, and possibly damaging, critical operating system data.

The kernel 240 components include a thread manager and scheduler 242, an input manager 246, and a network connection manager 248. An operating system kernel may include additional components. The thread manager 240 handles the execution of threads in a process. An instance of a program runs in a process. Every process has an ID, a number that identifies it. A thread is a schedulable entity within a process, a stream of execution within a process.

The input manager 246 facilitates hardware input. A computer consists of various devices that provide I/O to and from the outside world. Typical devices are keyboards, mice, audio controllers, video controllers, disk drives, networking ports, and so on. Device drivers provide the software connection between the devices and the operating system. The input manager 246 manages the communication between applications and the interfaces provided by device drivers. The input manager 246 may determine or have access to the control focus of the operating system. The control focus is used to determine an input destination for the keyboard 126. The application or container having the current control focus is the input destination. As control focus changes to different applications, containers, or operating system components, the input destination changes. Control focus may change when a user selects a user interface component associated with an application, container, or operating system component. In an aspect, the input manager 240 may communicate the identity of the input destination to the keyboard 126 and/or the keyboard driver 249.

In an aspect, the input manager 246 communicates and/or makes available capability information about the keyboard 126 to the input destination (e.g., container 214). The capability information may enable the input destination to determine that the keyboard 126 is able to enter secure mode. The capability information may also facilitate routing of an initial request for the keyboard to enter secure mode. For example, the capability information may be used to identify the keyboard driver 249 and/or an API feature to which the initial request should be addressed. The capability information may be accessed through a uniform resource locator (URL) through which keyboard model information and capabilities are available.

The keyboard driver 249 helps the keyboard function in secure mode and may play a role in standard mode. As mentioned, standard mode enables the keyboard to communicate with non-security enabled input destinations and/or security enabled input destinations that have not activated the security feature. In standard mode, the keyboard driver 249 may receive a scan code from the keyboard 126 and convert it to a virtual key, which is communicated as an operating system message by the input manager 246 (or other component) to the input destination. In an aspect, the virtual key is input to a keystroke queue designed to receive and communicate virtual keys to input destinations. If a computing system has multiple keyboards, the same keystroke queue may receive virtual keys from each. The input destination receives the virtual key from the keystroke queue through various operating system operations depicted as communication channel 272. The communication may be a push operation to the input destination or a pull operation initiated by the input destination. Key loggers may attempt to intercept virtual keys by monitoring the keystroke queue or other component. In standard mode, the virtual keys are not encrypted and are understandable if intercepted.

In secure mode, the keyboard driver 249 can help initiate an alternative communication channel 270 for communications between the container 214 and the keyboard 126. Though not depicted as involving the input manager 246, the alternative communication channel 270 may or may not include the input manager 240. A first purpose of the alternative communication channel 270 is for the container 214 to request secure mode and complete a communication of authentication messages between the keyboard 126 and the container 214. A second purpose of the alternative communication channel 270 is to communicate encrypted keystrokes from the keyboard to the container 214. These features will be described in more detail subsequently with reference to the keyboard 126.

The network connection manager 248 manages communications between the NIC 258, operating system components, and applications. The network connection manager 248 may provide network context information. The network manager may interact with one or more drivers to implement networking in the operating system.

The operating system 220 components may reside outside of the kernel and comprise a Local Security Authority Subsystem Service (LSASS) 234. Other operating system components are omitted from FIG. 2 for the sake of simplicity.

The LSASS 234 is responsible for enforcing the security policy on the system. It verifies users logging on to a computer or server, handles password changes, and creates access tokens. The LSASS may provide stored credentials or secrets to other components described herein.

The shell 230 is the portion of the operating system that allows the user to communicate with the operating system 220, including the kernel 240. The operating system 220 also comprises components, such as user interface component 222, clipboard 224, notification component 226, and authorization dialogs 228. The user interface component 222 provides the operating system's main user interface. The clipboard 224 is an interface feature that may capture objects (e.g., files, text, images) in the operating system user interface and/or application interfaces and perform an operation on the captured object (e.g., copy, cut, move). For example, the clipboard 224 may allow a user to copy text from a first application interface to a different interface or different location in the first application interface. The notification component 226 manages notifications provided through the operating system. The notifications may originate from an application or service, such as an email application or social media service. The authorization dialog 228 allows the user to provide and/or confirm information that is used to authenticate the user to various entities and components.

The keyboard 126 includes the security application 261, the encryptor 262, and the visual attestation component 264. The security application 261 and the encryptor 262 are used in secure mode. The security application 261 may maintain a mode status indicating whether the keyboard is in secure or standard mode. The security application 261 may expose the mode status to the visual attestation component 264.

The visual attention component 264 activates a visual attestation through the keyboard 126 when the keyboard 126 is in secure mode. The visual attention component 264 deactivates the visual attestation through the keyboard 126 when the keyboard 126 is in standard mode. The visual attestation may be any type of computer-generated visual output through the keyboard. In one implementation, the visual attestation is a light (e.g., green light) that may be associated with a label, such as “secure mode on.” A second light (e.g., red light) may be associated with a label, such as “secure mode off.” In some configurations, such as the example shown in FIG. 1, the visual display can be in the form of an LCD. The LCD may be used to provide additional information, such as identification of the input destination, in this example, container 214. It should be understood that other forms of display may be used, and other computer-generated attestation concepts may be implemented.

The security application 261 helps generate a secure connection between the keyboard 126 and the container 214. A first aspect of secure mode may be authentication of the keyboard to the container. A second aspect of the secure mode may be the establishment of an alternative or nonstandard communication channel 270 between the keyboard 126 and the container 214. In this case, “nonstandard” means a communication channel different from the default communication channel used to communicate keystrokes to an input destination. A third aspect of the secure mode may include the encryption of the keystrokes. The encryption and decryption may be primarily handled by the encryptor 262 and the decryptor 218, respectively. However, the security application 261 may facilitate the exchange of encryption keys and other information needed to encrypt and/or decrypt keystrokes.

As mentioned, the security application 261 may authenticate the keyboard 126 to the container 214 to generate a secure session. In an aspect, authentication is initiated by the container 214 communicating a secure-mode initiation request to the keyboard 126. This message may initially be communicated to the keyboard driver 249 via communication channel 270. The communication channel 270 may be discovered by the container 214 through the capability information retrieved by or communicated to the container 214, in some aspects by the input manager 246. The driver-side security application 263 may receive the secure-mode initiation request and communicate it to the security application 261 on the keyboard 126.

The secure-mode initiation request may include cryptographic information such as an encryption version and/or communication protocol to use when communicating with the container 214. In an aspect, multiple encryption versions and/or protocols may be received in the secure-mode initiation request and/or as part of authentication in various messages. The multiple versions may be provided in order of use preference. The keyboard may then select a highest ranked compatible version for use based on connectivity or user preferences. As an alternative to selecting the highest ranked compatible version, which defers to the input destination preference, the keyboard may employ a heuristic to select among the compatible versions based on keyboard efficiencies or other criteria. The protocols may include a data compression method to be used during communications. Data compression may be optional, as keystrokes and/or scan codes are not large objects. The initial secure-mode initiation request may also include a byte string used in subsequent computations. The byte string may serve as a public key for the container 214.

The security application 261 may respond with a secure-mode response message. The response message may include identification of the encryption version and/or protocol version to be used. The response message may also include a session ID. A different session ID may be issued by the security application 261 each time secure mode is entered. The session ID can serve multiple purposes. The session ID can indicate that a keystroke is from an input device that has been authenticated, because other input devices should not know the session ID. The response may also include a second byte string that serves as a public key for the keyboard. A public key may be used during the authentication process. For example, the public key may be sent to a third party certificate authority for authentication. The security application 261 may also include a digital certificate as part of an authentication requirement. In one aspect, the keyboard 126 may also request a security certificate from the container 214 to certify that a secure-mode may be established with the container 214. The security certificates may be authenticated by a third-party authentication service, which may also be the entity that issued the certificates. The response may then be communicated to the container 214.

In an aspect, the container 214 uses a third-party authentication service to validate the certificate provided by the keyboard 126. Upon validation, the third-party authentication service may provide a secret key to be used for the encryption. The secret key may be encrypted using the keyboard's 126 public key when sent to the keyboard. The secret key may also be encrypted using the container's public key when sent to the container 214. In an aspect, the secret key is sent to both the keyboard 126 and the container 214 by the third-party authentication service. In another aspect, the secret key is sent to either the keyboard 126 or the container 214 by the third-party authentication service. The entity that received the secret key then communicates to the entity that did not receive the secret key. If the certificate is not validated, a warning or failure message may be communicated to the keyboard 126 and/or the container 214.

The encryptor 162 can encrypt data using various forms of encryption. The keyboard 126 and container 214 may both be capable of multiple encryption methods. CBC-3DES is one type of encryption that may be used. CBC-3DES is a cryptographic function that combines the data encryption standard (DES) with cipher block chaining (CBC). “3DES” means that the DES encryption algorithm is applied to a given block of data three times (“triple-DES”). DES encrypts data by applying a key to the data in a known manner. DES encrypts a long message by dividing the message into smaller blocks, and encrypting the individual blocks. (When “triple-DES” is used, the DES algorithm is applied to each block three times in order to produce the ciphertext for that block.) DES (and triple-DES) can encrypt each block of data using just a key; however, when cipher block chaining is used, the encryption of one block is based not only on the key, but also on the ciphertext that was produced by encrypting the last block. Thus, encryption of a given block is based on two inputs: the key, and the ciphertext that resulted from encrypting the previous block. Since the first block of data to be encrypted has no “previous” block, the cipher block chaining process must be primed with an “initial value”—that is, the first block of data is encrypted based on the key and some initial value. The initial value is not used in the encryption of subsequent blocks, but may indirectly influence how those blocks are encrypted (since the first block's ciphertext is based on the initial value, the second block's ciphertext is based on the first block's ciphertext, and so on). It should be understood that any other block cipher could be used, and chaining concepts similar to CBC could be applied to such a block cipher.

In some aspects, the OS is updated to recognize the data format of the encrypted keystroke. For example, the keystroke queue may be updated to handle a first type of keystrokes in the standard mode and a second type of encrypted keystrokes that follow a different format generated in secure mode. In aspects, the encrypted keystrokes may include more bytes of data than unencrypted keystrokes. The additional bytes of data may facilitate more complex cryptographic methods.

In some aspects, the OS is not updated to recognize the data format of the encrypted keystroke. The OS may be used “as-is” to direct the encrypted keystrokes as part of keystroke events to the container using the standard keystroke queue described previously. This is the standard communication channel through which keystrokes are communicated to the input destination. In order to use the standard communication channel, the encrypted keystrokes may follow the same data format as the keystrokes generated in standard mode. The standard data format may include a header and payload. The standard payload may have a byte limit. The encrypted keystroke may have an unencrypted header, but an encrypted payload. In aspects where the OS is not updated, the encrypted payload will fall within the byte limit used by standard keystrokes. Accordingly, in an aspect, the keyboard 126 generates a data object that conforms to the requirements of a keystroke typically communicated to the input manager 246, except that the payload in the data object is encrypted and the container 214 has the key.

The OS may facilitate the communications communication channel 270. As described previously, the communication channel 270 may be used to communicate authentication messages. In one aspect, the communication channel 270 is also used to communicate the encrypted keystrokes.

Another form of encryption is a one-to-one cypher. In a one-to-one cypher, the scan code typically associated with a first key is not generated by the keyboard in response to receiving a keystroke for the first key. Instead, a scan code for typically associated with a second key is used. This cyphered scan code is then communicated by the keyboard to the computing system, which translates the scan code into the character associated with the second key. This character is then communicated to the container. The security application on the container uses a cypher key to translate the character into the character associated with the first key. The cypher key could be exchanged during set up of a secure communication. The one-to-one cypher works without modification to the keyboard driver or operating system functions. The one-to-one cypher can be implemented by the first security application associated with the keyboard and the second security application associated with the container. In aspects, the operating system does not have access to the cypher key.

Another form of encryption is a one-to-many cypher. In a one-to-many cypher, multiple scan codes are generated by the keyboard in response to a single keystroke. For example, ten, one-hundred, one-thousand or more scan codes may be generated by the keyboard in response to the single keystroke and communicated to the computing device. The operating system and/or keyboard driver then translates the plurality of scan codes representing the single keystroke into corresponding characters and communicates the corresponding characters to the container. The plurality of scan codes representing the single keystroke may be bounded by delimiters. The decryptor 218 on the container uses a cypher key to translate the plurality of characters into the character associated with the single input. The cypher key may be exchanged during set up of a secure communication. The one-to-many cypher may be implemented without modification to the keyboard driver or operating system functions. The one-to-many cypher may be implemented by the first security application 261 associated with the keyboard and the second security application 215 associated with the container. In aspects, the operating system does not have access to the one-to-many cypher key.

Another form of encryption is encryption of the scan code by the keyboard. In aspects, the scan code is encrypted using an encryption method to form an encrypted scan code. The encrypted scan code is then communicated to the operating system, which is not able to decrypt the encrypted scan code. In an aspect, the OS communicates the encrypted scan code to the container.

The container 214 may include a decryptor 218, security application 215 and other applications not shown for the sake of simplicity. Decryptor 218 decrypts data using the algorithm and keys used by the encryptor 262. Decryption is the process of converting ciphertext back to plaintext. In aspects, the security application 215 may generate a secure-mode termination request upon losing control focus. In response to receiving the secure-mode termination request, the keyboard 126 may return to standard mode. In aspects, a user may also provide an instruction through an interface provided by the container 214 to activate or deactivate the secure mode.

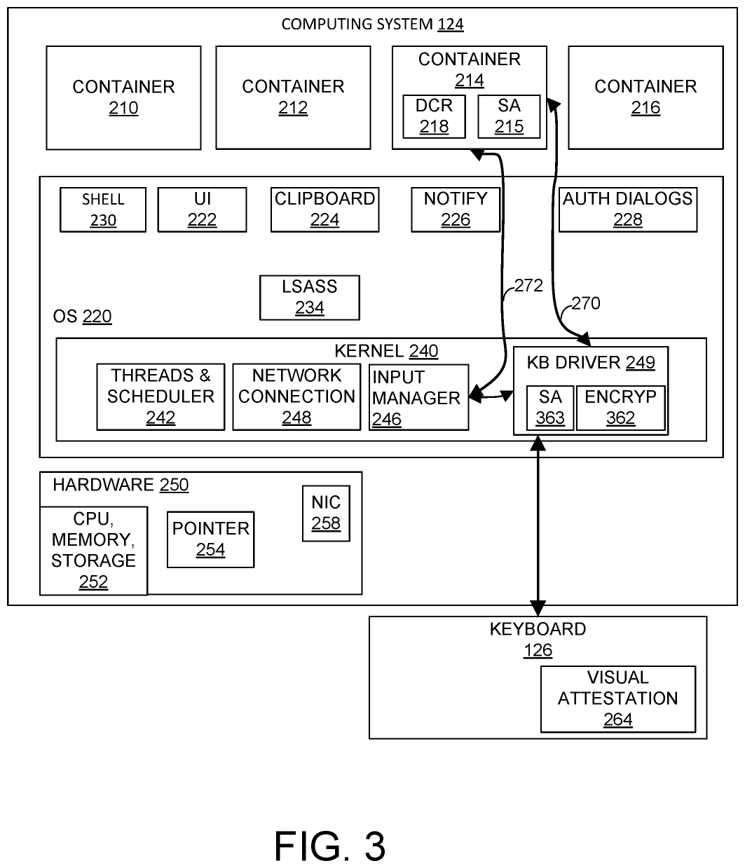

FIG. 3 illustrates how encryption may occur at the keyboard driver 249, rather than the keyboard 126. In aspects, the various functions of secure mode may be distributed between the driver 249 and the keyboard 126. In this example, the steps described as performed by the encryptor 262 are instead performed by the driver-side encryptor 362. The security application 363 performs the functions of security application 261 and driver-side security application 263.

### Example Methods

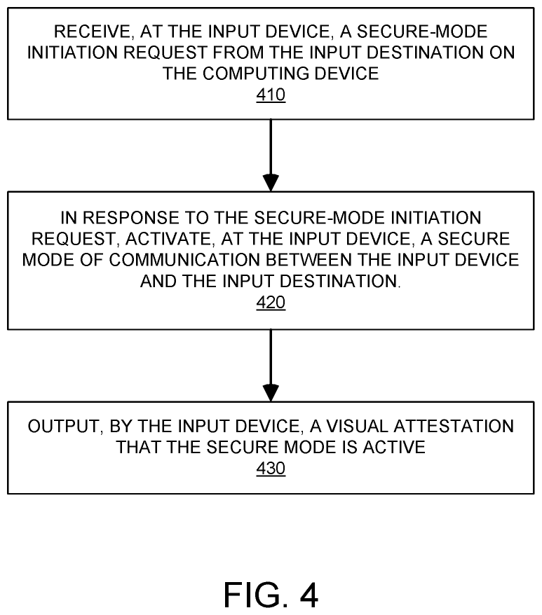

Now referring to FIGS. 4, 5 and 6, each block of methods 400, 500, and 600, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The method may be provided by an operating system. In addition, methods 400, 500, and 600 are described, by way of example, with respect to FIGS. 1-3. However, these methods may additionally or alternatively be executed by any one system, or any combination of systems, including, but not limited to, those described herein.

FIG. 4 is a flow diagram showing a method 400 of securing communication of input data between an input destination on a computing device and an input device, in accordance with some embodiments of the present disclosure. Method 400 may be performed on or with systems similar to those described with reference to FIGS. 1-3.

At step 410, the method 400 includes receiving, at the input device, a secure-mode initiation request from the input destination on the computing device. In aspects, the input device may be a keyboard. The input device may have a standard mode and a secure mode. The default mode may be standard mode, which may work with all input destinations. In contrast, the secure mode may be available to only certain input destinations and require the exchange of a secret key for encryption. The secret key may be exchanged as part of an authentication process that involves the exchange of security certificates.

At step 420, the method 400 includes, in response to the secure-mode initiation request, activating, at the input device, a secure mode of communication between the input device and the input destination. Activation of the secure mode may include the exchange of a secret key for use in encryption. In addition, an encryption protocol to be used may be established in the exchange of messages between the input destination and the input device. Further, various communication protocols including a communication channel within the operating system may be established.

At step 430, the method 400 includes outputting, by the input device, a visual attestation that the secure mode is active. The visual attestation may include a light on a keyboard or other visible indication that the input device is in secure mode. The visual attestation indicates to the user that any provided input is secured. The visual attestation may be removed when the input device returns to standard mode. The input device may return to standard mode in response to a secure mode termination message received from the input destination or other component. For example, the control focus of the operating system may be communicated to the input device. A control focus change can serve as a termination message. In an aspect, an application (e.g., driver) associated with the input device monitors the control focus and communicates the control focus changes to the input device.

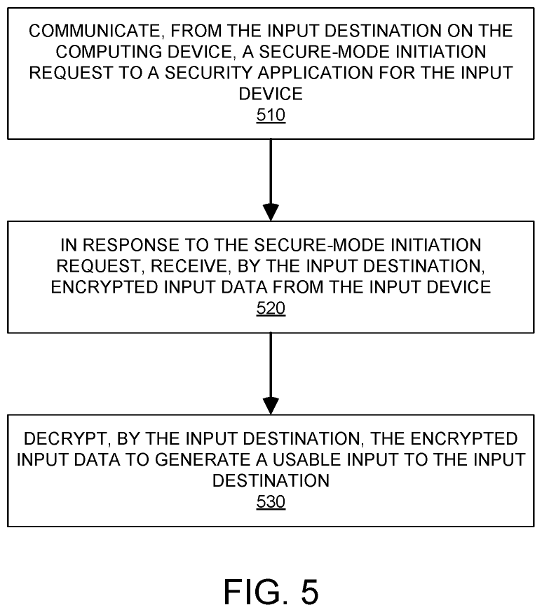

FIG. 5 is a flow diagram showing a method 500 of securing communication of input data between an input destination on a computing device and an input device, in accordance with some embodiments of the present disclosure. Method 500 may be performed on or with systems similar to those described with reference to FIGS. 1-3.

At step 510, the method 500 includes communicating, from the input destination on the computing device, a secure-mode initiation request to a security application for the input device. The secure-mode initiation request may be communicated upon learning that the input device has a secure mode available. The input destination may learn that the input device has a secure mode by evaluating the capabilities of the input device. Communicating a secure-mode initiation request may initiate an exchange of messages between the input destination and the input device that include a secret key for encryption as well as various authentication steps.

At step 520, the method 500 includes, in response to the secure-mode initiation request, receiving, by the input destination, encrypted input data from the input device.

At step 530, the method 500 includes decrypting, by the input destination, the encrypted input data to generate a usable input for the input destination. The input destination may decrypt the encrypted input data and use the input.

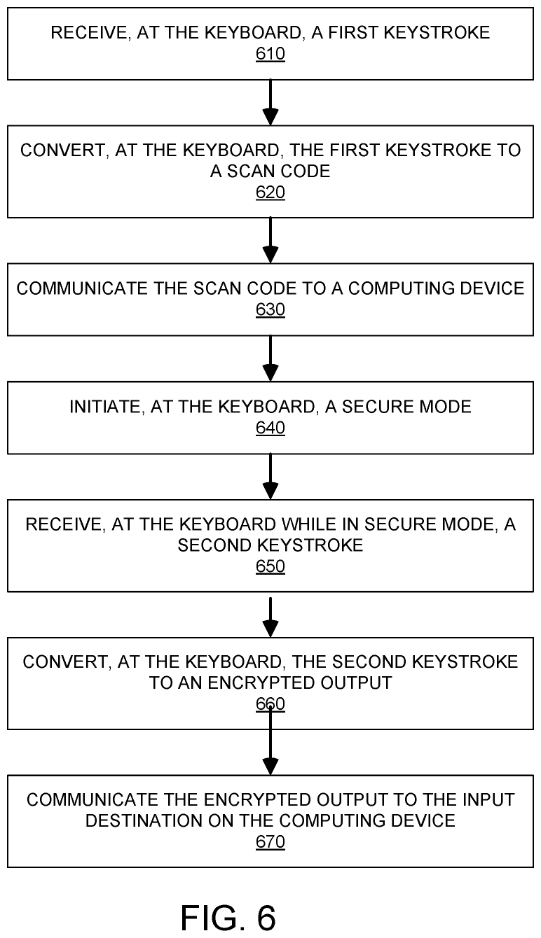

FIG. 6 is a flow diagram showing a method 600 of securing communication of input data between an input destination on a computing device and an input device, in accordance with some embodiments of the present disclosure. Method 600 may be performed on or with systems similar to those described with reference to FIGS. 1-3.

At step 610, the method 600 includes receiving, at the keyboard, a first keystroke. The first keystroke may be generated by a user depressing a key on a physical keyboard and/or interacting with the key on a touchscreen keyboard. The circuitry in the keyboard may convert the first keystroke into a digital signal.

At step 620, the method 600 includes converting, at the keyboard, the first keystroke to a scan code. The scan code can follow a protocol that encodes the keystroke according to a format that can be understood by a recipient.

At step 630, the method 600 includes communicating the scan code to a computing device. The scan code may be communicated to a driver and/or input manager on the computing device. The driver and/or input manager may translate the scan code into a virtual keystroke or other format that may be understood by input destination. For example, if the scan code encoded the lowercase letter a, then the virtual keystroke would be understood by input destination as the lowercase letter a.

At step 640, the method 600 includes initiating, at the keyboard, a secure mode. Secure mode may be initiated in response to a secure-mode initiation request communicated by the input destination to the keyboard.

At step 650, the method 600 includes receiving, at the keyboard while in secure mode, a second keystroke. At step 660, the method 600 includes converting, at the keyboard, the second keystroke to an encrypted output. The encrypted output is generated using a secret key known to the input destination. This allows the input destination to decrypt the encrypted output. In aspects, secret key is known only to the keyboard and the input destination. The operating system and other applications running on the computing device will not have the secret key.

At step 670, the method 600 includes communicating the encrypted output to the input destination on the computing device. In aspects, the encrypted output may be included as a message payload by one or many operating system components and/or drivers responsible for communicating keystrokes to input destinations. For example, the encrypted output may be communicated in a message following a first format to a driver and/or input manager. The driver and/or input manager may incorporate the encrypted output into a second message that follows a second format. The second message may be communicated to the input destination. In other aspects, the encrypted output is communicated to the input destination in the format it is in when it leaves the keyboard.

### Example Operating Environment

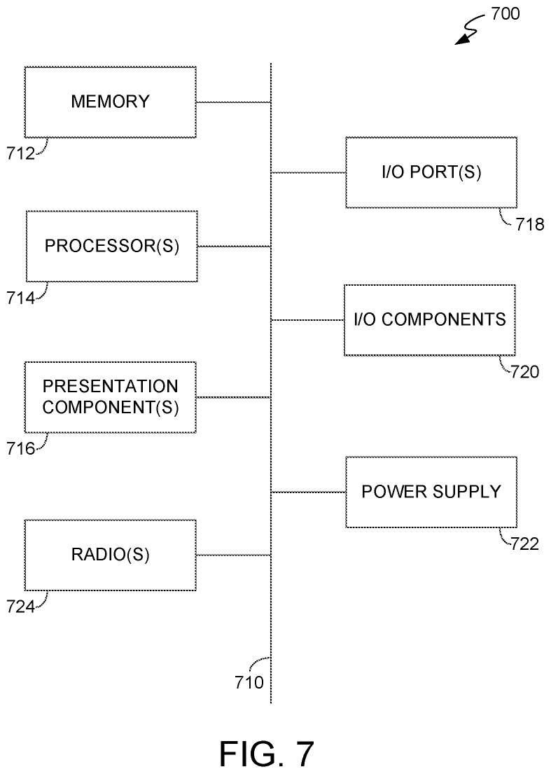

Referring to the drawings in general, and initially to FIG. 7 in particular, an example operating environment for implementing aspects of the technology described herein is shown and designated generally as computing device 700. Computing device 700 is but one example of a suitable computing environment and is not intended to suggest any limitation as to the scope of use of the technology described herein. Neither should the computing device 700 be interpreted as having any dependency or requirement relating to any one or combination of components illustrated.

The technology described herein may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. The technology described herein may be practiced in a variety of system configurations, including handheld devices, consumer electronics, general-purpose computers, specialty computing devices, etc. Aspects of the technology described herein may also be practiced in distributed computing environments where tasks are performed by remote-processing devices that are linked through a communications network.

With continued reference to FIG. 7, computing device 700 includes a bus 710 that directly or indirectly couples the following devices: memory 712, one or more processors 714, one or more presentation components 716, input/output (I/O) ports 718, I/O components 720, and an illustrative power supply 722. Bus 710 represents what may be one or more busses (such as an address bus, data bus, or a combination thereof). Although the various blocks of FIG. 7 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art and reiterate that the diagram of FIG. 7 is merely illustrative of a computing device that may be used in connection with one or more aspects of the technology described herein. Distinction is not made between such categories as “workstation,” “server,” “laptop,” “handheld device,” etc., as all are contemplated within the scope of FIG. 7 and refer to “computer” or “computing device.”

Computing device 700 typically includes a variety of computer-readable media. Computer-readable media may be any available media that may be accessed by computing device 700 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 712 includes computer storage media in the form of volatile and/or nonvolatile memory. The memory 712 may be removable, non-removable, or a combination thereof. Example memory includes solid-state memory, hard drives, optical-disc drives, etc. Computing device 700 includes one or more processors 714 that read data from various entities such as bus 710, memory 712, or I/O components 720. Presentation component(s) 716 present data indications to a user or other device. Example presentation components 716 include a display device, speaker, printing component, vibrating component, etc. I/O ports 718 allow computing device 700 to be logically coupled to other devices, including I/O components 720, some of which may be built in.

Illustrative I/O components include a microphone, joystick, game pad, satellite dish, scanner, printer, display device, wireless device, a controller (such as a stylus, a keyboard, and a mouse), a natural user interface (NUI), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 714 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may coexist with the display area of a display device, be integrated with the display device, or may exist as a separate device overlaying or otherwise appended to a display device. Any and all such variations, and any combination thereof, are contemplated to be within the scope of aspects of the technology described herein.

An NUI processes air gestures, voice, or other physiological inputs generated by a user. Appropriate NUI inputs may be interpreted as ink strokes for presentation in association with the computing device 700. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 700. The computing device 700 may be equipped with depth cameras, such as stereoscopic camera systems, infrared camera systems, RGB camera systems, and combinations of these, for gesture detection and recognition. Additionally, the computing device 700 may be equipped with accelerometers or gyroscopes that enable detection of motion. The output of the accelerometers or gyroscopes may be provided to the display of the computing device 700 to render immersive augmented reality or virtual reality.

A computing device may include a radio 724. The radio 724 transmits and receives radio communications. The computing device may be a wireless terminal adapted to receive communications and media over various wireless networks. Computing device 700 may communicate via wireless policies, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 policies.

### EMBODIMENTS

The technology described herein has been described in relation to particular aspects, which are intended in all respects to be illustrative rather than restrictive. While the technology described herein is susceptible to various modifications and alternative constructions, certain illustrated aspects thereof are shown in the drawings and have been described above in detail. It should be understood, however, that there is no intention to limit the technology described herein to the specific forms disclosed, but on the contrary, the intention is to cover all modifications, alternative constructions, and equivalents falling within the spirit and scope of the technology described herein.

What is claimed is:

1. One or more computer storage media comprising computer-executable instructions that when executed by an input device perform a method of securing communication of input data between an input destination on a computing device and the input device, the method comprising:
receiving, at the input device, a secure-mode initiation request from the input destination on the computing device;
in response to the secure-mode initiation request, activating, at the input device, a secure mode of communication between the input device and the input destination; and
outputting, by the input device, a visual attestation that the secure mode is active.

2. The media of claim 1, wherein the method further comprises
generating, by the input device, input data in response to a user input;
encrypting, by the input device, the input data to generate encrypted input data; and
communicating, by the input device, the encrypted input data to the input destination.

3. The media of claim 2, wherein the input destination has a decryption key for the encrypted input data.

4. The media of claim 1, in response to the secure-mode initiation request, communicating, by the input device, authentication data to the input destination.

5. The media of claim 4, wherein the authentication data includes an authentication certificate.

6. The media of claim 1, wherein the input destination is a container running on the computing device.

7. The media of claim 1, wherein the input device is a keyboard.

8. A method of securing communication of input data between a input destination on a computing device and an input device, the method comprising:
communicating, from the input destination on the computing device, a secure-mode initiation request to a security application for the input device;
in response to the secure-mode initiation request, receiving, by the input destination, encrypted input data from the input device; and
decrypting, by the input destination, the encrypted input data to generate a usable input to the input destination.

9. The method of claim 8, further comprising outputting through a user interface, associated with the input destination, an attestation that a secure mode is active.

10. The method of claim 8, wherein the input destination is an application in control focus.

11. The method of claim 8, wherein the input destination is a container that leverages a host operating system, wherein the host operating system is installed on the computing device.

12. The method of claim 8, further comprising receiving, in response to the secure-mode initiation request, a validation certificate for the input device.

13. The method of claim 8, wherein the security application for the input device is associated with a driver for the input device, wherein the driver and the security application are installed at a driver layer of an operating system installed on the computing device.

14. The method of claim 8, wherein the security application for the input device is installed on the input device.

15. A method of for implementation of a secure mode for communicating input data between a keyboard and an input destination, comprising:
receiving, at the keyboard, a first keystroke;
converting, at the keyboard, the first keystroke to a scan code;
communicating the scan code to a computing device;
initiating, at the keyboard, a secure mode;
receiving, at the keyboard while in secure mode, a second keystroke;
converting, at the keyboard, the second keystroke to an encrypted output; and
communicating the encrypted output to the input destination on the computing device.

16. The method of claim 15, further comprising receiving, from the input destination on the computing device, a request to activate the secure mode.

17. The method of claim 15, further comprising receiving a secret key to use in encryption.

18. The method of claim 15, further comprising, upon activating the secure mode, outputting an attestation display provided on a section of an upper surface of the keyboard.

19. The method of claim 15, further comprising, in response to a secure-mode initiation method, providing a validation certificate to the input destination.

20. The method of claim 15, receiving a secure-mode termination request and returning to standard mode.
